(19) United States
(12) Patent Application Publication
(10) Pub. No.: US 2008/0221777 A1
(43) Pub. Date: Sep. 11, 2008

(54) MODEL SIMPLIFICATION METHOD FOR MODEL-BASED DEVELOPMENT

(75) Inventor: Takanori Degaki, Numazu-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/033,172

(22) Filed: Feb. 19, 2008

(30) Foreign Application Priority Data
Mar. 6, 2007 (JP) 2007-055887

(51) Int. Cl. G06F 17/00

(52) U.S. Cl. 701/103

(57) ABSTRACT

The invention provides a model simplification method for model-based development for installing a simplified model of a predetermined system of a vehicle in a vehicle ECU so as to control an engine. The simplified model is different from a detailed model used for designing the predetermined system. The method includes (1) performing an inverse calculation to determine a conformance value for making the simplified model conform to an actual engine, using the simplified model; and calculating a value required for performing the inverse calculation to determine the conformance value, using the detailed model.

### INCORPORATION BY REFERENCE

The disclosure of Japanese Patent Application No. 2007-055887 filed on Mar. 6, 2007, including the specification, drawings and abstract is incorporated herein by reference in its entirety.

### BACKGROUND OF THE INVENTION

1. Field of the Invention

The invention relates to a model simplification method for model-based development.

2. Description of the Related Art

In recent years, there has been a growing need for an accurate air-fuel ratio control in an internal combustion engine of a vehicle. In order to perform such accurate air-fuel ratio control, it is necessary to accurately detect or estimate an amount of intake air that is supplied to each cylinder. The intake air amount detected by an air flow meter is relatively accurate when the internal combustion engine is in a steady state. However, during a transitional period of the internal combustion engine, there may be a delay in response of the air flow meter, and thus the detected value may be inaccurate.

Due to the reason described above, for example, in Japanese Patent Application Publication No. 2003-314347 (JP-A-2003-314347), a technology in which an output from the air flow meter is corrected based on an engine speed during the transitional period of the internal combustion engine is proposed. Further, Japanese Patent Application Publications No. 2005-157777 (JP-A-2005-157777) and No. 2005-165606 (JP-A-2005-165606) also describe the related arts. However, even if the output from the air flow meter is corrected as described above, this does not guarantee that the intake air amount is always accurately estimated during the transitional period of the internal combustion engine, and thus, it is still necessary to accurately estimate the intake air amount by modeling an intake system of the internal combustion engine.

It is preferable that not only the intake air amount but also other values used for controlling the engine should be calculated by installing a model of each system of the vehicle in a vehicle ECU (electronic control unit), and using the model of each system. However, it is not practical to provide the vehicle ECU with a detailed model (for example, three-dimensional numerical calculation model) used for designing each system of the vehicle, because the time required for performing calculation using the detailed model in the vehicle ECU tends to be tremendously long.

Therefore, the simplified model of each system, which is different from the detailed model, is installed in the vehicle ECU. However, a conformance value for making the simplified model conform to an actual engine needs to be set through a conformance testing, and the conformance testing requires a large number of man-hours.

### SUMMARY OF THE INVENTION

The invention has been made in consideration of the foregoing, and provides a model simplification method by which a conformance value used in a simplified model of a predetermined system of a vehicle, which is different from a detailed model used for designing the predetermined system, can be easily determined in model-based development for installing the simplified model in a vehicle ECU so as to control an engine.

An aspect of the invention relates to a model simplification method for model-based development for installing a simplified model of a predetermined system of a vehicle, which is different from a detailed model used for designing the predetermined system of the vehicle, in a vehicle ECU so as to control an engine. The method includes performing an inverse calculation to determine a conformance value for making the simplified model conform to an actual engine, using the simplified model; and calculating a value required for performing the inverse calculation to determine the conformance value, using the detailed model.

According to the model simplification method for the model-based development for installing the simplified model of the predetermined system of the vehicle, which is different from the detailed model used for designing the predetermined system, in the vehicle ECU so as to control the engine as described above, the conformance value for making the simplified model conform to the actual engine is determined by the inverse calculation using the simplified model. Further, the values required for performing the inverse calculation to determine the conformance value are calculated using the detailed model. Accordingly, there is no need for performing the conformance testing in which the actual engine is used in order to determine the conformance value, and therefore the conformance value can be easily determined.

Further, in the model simplification method for the model-based development as described above, the simplified model may include a plurality of partial models. Still further, the partial models included in the simplified model may be automatically selected from a partial model library for the simplified model so that the partial models included in the simplified model correspond to respective partial models included in the detailed model.

According to the model simplification method for the model-based development described above, the simplified model includes a plurality of partial models, and the partial models included in the simplified model are automatically selected from the partial model library for the simplified model so that the partial models included in the simplified model correspond to the respective partial models included in the detailed model. Accordingly, the simplified model can be easily set.

In the model simplification method for the model-based development as described above, an order of connecting the partial models included in the simplified model may be automatically set in accordance with an order of connecting the partial models included in the detailed model.

According to the model simplification method for the model-based development as described above, the order of connecting the partial models included in the simplified model is automatically set in accordance with the order of connecting the partial models included in the detailed model. Accordingly, the simplified model can be easily set.

Still further, in the model simplification method for the model-based development as described above, each of the simplified model and the detailed model may be a model of an intake system of an internal combustion engine mounted in the vehicle, and the conformance value for making the simplified model conform to the actual engine may be a flow coefficient of intake air that passes through a throttle valve.

According to the model simplification method for the model-based development as described above, each of the simplified model and the detailed model is the model of the intake system of the internal combustion engine mounted in the vehicle, and the conformance value for making the simplified model conform to the actual engine is the flow coefficient of intake air that passes through the throttle valve. Therefore, the flow coefficient, which is the conformance value, can be easily determined.

Further, the partial models may include an air cleaner partial model, a throttle partial model, a surge tank partial model, and an intake port partial model.

Further, a pressure of intake air that flows into the air cleaner partial model may be set to standard atmospheric pressure.

Further, a pressure value of intake air that flows out of the air cleaner partial model may be set to an average of pressure values in elements that are set by dividing a cross section of an intake passage at a most upstream end of the throttle partial model.

A flow rate of intake air that passes through the air cleaner partial model may be determined by calculating a value by multiplying a product of a flow velocity vn and a density ρn in each of elements located at a most upstream end of the throttle partial model by a sectional area an of the element, and adding up all the values, as shown by a formula below.

$$m = {\sum }_{i = 1}^{n} vi \times ρ i \times ai$$

### BRIEF DESCRIPTION OF THE DRAWINGS

The features, advantages, and technical and industrial significance of this invention will be better understood by reading the following detailed description of preferred embodiments of the invention, when considered in connection with the accompanying drawings, in which:

FIG. 1 is a diagram schematically showing a model simplification method according to the invention;

FIG. 2 schematically shows an intake system corresponding to a simplified intake system model;

FIG. 3 schematically shows a throttle partial model of a detailed intake system model;

FIG. 4 is a schematic sectional view of the throttle partial model of the detailed intake system model in a longitudinal direction of an intake passage; and

FIG. 5 is a sectional view taken along the line A-A in FIG. 4.

### DETAILED DESCRIPTION OF EMBODIMENTS

In the following description and the accompanying drawings, the present invention will be described in more detail with reference to exemplary embodiments.

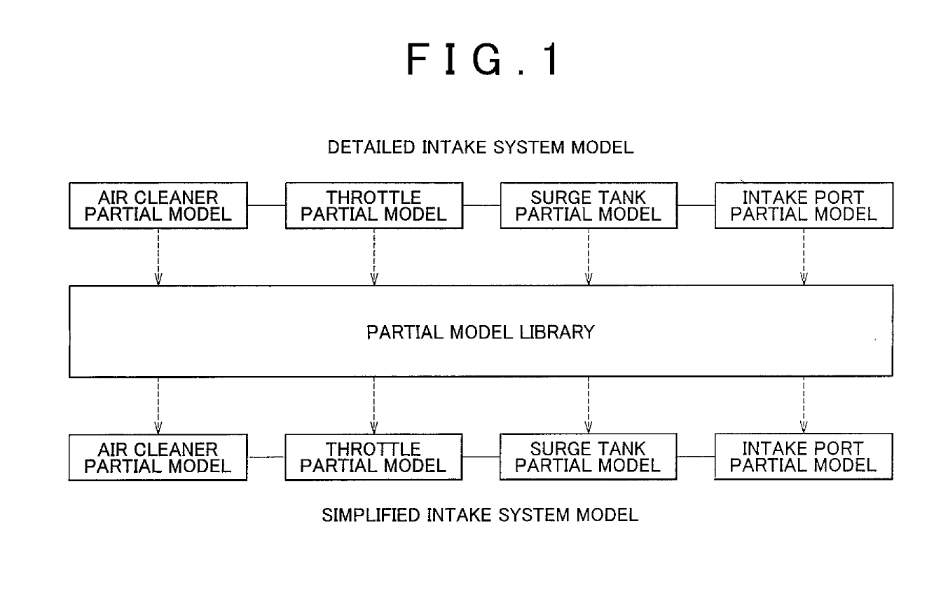

FIG. 1 is a diagram schematically showing a model simplification method according to the invention for setting a simplified model that is installed in a vehicle ECU so as to control an engine, such as a simplified intake system model. When designing an intake system of the engine, for example, the engine intake system is modeled in detail so that pressure, temperature, flow velocity, density, enthalpy, etc. in each portion of the engine intake system are calculated using the three-dimensional computational fluid dynamics (3D-CFD). A multi-purpose calculation program of the three-dimensional fluid dynamics is commercially available under the product name of STAR-CD or FLUENT.

In a vehicle to which the engine intake system thus designed is mounted, it is necessary to accurately estimate an amount of intake air even during a transitional period of the engine, in order to perform accurate air-fuel ratio control. Accordingly, it is necessary to model the engine intake system and install the model of the intake system in the vehicle ECU, and then calculate the intake air amount at each time point with respect to each value of a throttle valve opening degree that varies during the transitional period of the engine.

The calculation load is large when the calculation is performed using the three-dimensional computational fluid dynamics in the detailed model. Therefore, in the vehicle ECU, it is not possible to calculate the intake air amount at each time point during the transitional period of the engine, using the detailed model. Thus, the model installed in the vehicle ECU and used to control the engine needs to be a simplified model in which the calculation load is small, instead of the detailed model used for designing the intake system.

In the embodiment, as shown in FIG. 1, there is provided a partial model library that houses partial models used to set the simplified model. When the detailed model for designing the engine intake system is set, and information about the plurality of partial models included in the detailed model (for example, an air cleaner partial model, a throttle partial model, a surge tank partial model, and an intake port partial model) and about an order of connecting the partial models of the detailed model is input to the partial model library, the partial models of the simplified model are automatically selected from the partial model library so that the partial models of the simplified model correspond to the respective partial models of the detailed model. Then, the selected partial models of the simplified model are automatically connected in the same order as the order in which the partial models of the detailed model are connected. In this way, the simplified model installed in the vehicle ECU (for example, the simplified model in which the air cleaner partial model, the throttle partial model, the surge tank partial model, and the intake port partial model are connected in this order) can be automatically produced.

The partial model library preferably houses all the partial models, such as a compressor partial model and an intercooler partial model of a turbocharger (not shown in FIG. 1), in addition to the air cleaner partial model, the throttle partial model, the surge tank partial model, and the intake port partial model, so that the simplified model that covers the entire intake system can be formed.

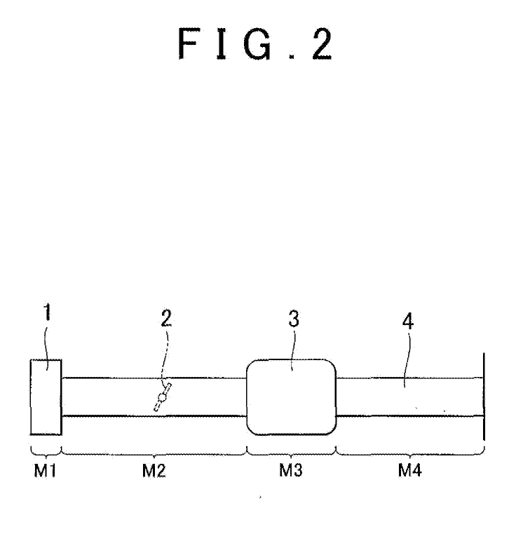

FIG. 2 schematically shows an intake system corresponding to the simplified intake system model configured as described above. In FIG. 2, the reference numeral 1 denotes an air cleaner, the reference numeral 2 denotes a throttle valve, the reference numeral 3 denotes a surge tank, and the reference numeral 4 denotes an intake port. As described above, by using the model simplification method for the model-based development according to the invention, the simplified intake system model is set so as to include an air cleaner partial model M1, a throttle partial model M2, a surge tank partial model M3, and an intake port partial model M4, which correspond to the air cleaner 1, the throttle valve 2, the surge tank 3, and the intake port 4 of the intake system, respectively.

A modeling formula for the air cleaner partial model M1 is, for example, the formula (1) below.

m=C×(Pin−Pout) (1)

In the formula (1), the symbol m denotes the flow rate of intake air that passes through the air cleaner partial model M1, and it is assumed that the flow rate of the intake air that flows into the air cleaner partial model M1 is equal to the flow rate of the intake air that flows out of the air cleaner partial model M1. The symbol C denotes the flow coefficient of the air cleaner 1. Further, the symbol Pin denotes the pressure of the intake air that flows into the air cleaner partial model M1, and the symbol Pout denotes the pressure of the intake air that flows out of the air cleaner partial model M1.

A modeling formula for the throttle partial model M2 is, for example, the formula (2) below.

$$m = Ct ( TA ) At ( TA ) Pin \sqrt{\frac{k + 1}{2 kRT}} \sqrt{{( \frac{k}{k + 1} )}^{2} - {( \frac{Pout}{Pin} - \frac{1}{k + 1} )}^{2}} \qquad ( 2 )$$

In the formula (2), the symbol m denotes the flow rate of the intake air that passes through the throttle valve 2, and it is assumed that the flow rate of the intake air that flows into the throttle partial model M2 is equal to the flow rate of the intake air that flows out of the throttle partial model M2. The symbol Ct denotes the flow coefficient of the throttle valve 2, which varies depending on a throttle valve opening degree TA. The symbol At denotes an opening area in the cross section of an intake passage at the position where the throttle valve 2 is located (hereinafter referred to as “opening area At around the throttle valve 2”). The opening area At around the throttle valve 2 varies depending on the throttle valve opening degree TA. Further, the symbol Pin denotes the pressure of the intake air that flows into the throttle partial model M2, and the symbol Pout denotes the pressure of the intake air that flows out of the throttle partial model M2. The symbol k denotes a ratio of specific heat, and the symbol R denotes a gas constant. The symbol T denotes the temperature of the intake air, and it is assumed that the temperature of the intake air that flows into the throttle partial model M2 is equal to the temperature of the intake air that flows out of the throttle partial model M2.

A modeling formula for the surge tank partial model M3 is, for example, the formulae (3) and (4) below.

$$\begin{matrix}\frac{d ( P / T )}{d t} = \frac{R}{V} ( m i n - mout ) & ( 3 ) \\ \frac{d P}{d t} = k \frac{R}{V} ( m i n Tin - moutTout ) & ( 4 )\end{matrix}$$

In the formulae (3) and (4), the symbol min denotes the flow rate of the intake air that flows into the surge tank partial model M3, and the symbol mout denotes the flow rate of the intake air that flows out of the surge tank partial model M3. The symbol P denotes the pressure of the intake air in the surge tank 3, and it is assumed that the pressure of the intake air that flows into the surge tank partial model M3 is equal to the pressure of the intake air that flows out of the surge tank partial model M3. The symbol V denotes (the design value of) the capacity of the surge tank, the symbol k denotes the ratio of specific heat, and the symbol R is the gas constant. Further, the symbol Tin denotes the temperature of the intake air that flows into the surge tank partial model M3, and the symbol Tout denotes the temperature of the intake air that flows out of the surge tank partial model M3.

Further, the same formula as the formula (3) and the formula (4) may be used as the modeling formula for the intake port partial model M4. In this case, the symbol min denotes the flow rate of the intake air that flows into the intake port partial model M4, and the symbol mout denotes the flow rate of the intake air that flows out of the intake port partial model M4. The symbol P denotes the pressure in the intake port 4, and it is assumed that the pressure of the intake air that flows into the intake port partial model M4 is equal to the pressure of the intake air that flows out of the intake port partial model M4. Further, the symbol V denotes (the design value of) the capacity of the intake port 4, the symbol k denotes the ratio of specific heat, and the symbol R denotes the gas constant. Further, the symbol Tin denotes the temperature of the intake air that flows into the intake port partial model M4, and the symbol Tout denotes the temperature of the intake air that flows out of the intake port partial model M4.

In the simplified model of the engine intake system described above, at each time point, on the assumption that the flow rate min, the pressure Pin, and the temperature Tin of the intake air that flows into each of the partial models are equal to the flow rate mout, the pressure Pout, and the temperature Tout of the intake air that flows out of the partial model located immediately upstream of the partial model, these values as described above are calculated based on a pressure P1 and a temperature T1 in the corresponding cylinder located downstream of the intake port partial model M4, an atmospheric pressure P2 and an atmospheric temperature T2 in a portion located upstream of the air cleaner partial model M1, and the throttle valve opening degree TA. In this way, the flow rate mout of the air that flows out of the intake port partial model M4 located most downstream among all the partial models is regarded as the flow rate of the intake air that flows into the cylinder at each time point. However, in each of the partial models, all of the flow rate, pressure, and temperature of the intake air do not necessarily vary, depending on the modeling formula used. For example, in the partial model in which the temperature of the intake air does not vary, the calculation is performed on the assumption that the temperature Tin and the temperature Tout are equal to the temperature Tout of the intake air that flows out of the partial model located immediately upstream of the partial model in which the temperature of the intake air does not vary.

In the simplified intake system model described above, for example, the flow coefficient of the throttle valve 2 in the throttle partial model M2, which varies depending on the throttle valve opening degree TA of the throttle valve 2 (the flow coefficient will be hereinafter referred to as “the flow coefficient Ct (TA)”), needs to be determined so that the throttle partial model M2 conforms to the intake system of the vehicle. If a conformance testing is performed using an actual engine to determine the flow coefficient Ct (TA), a large number of man-hours are required to perform the testing. In the embodiment, in order to omit such a conformance testing, an inverse calculation is performed to determine the flow coefficient Ct (TA) at each value of the opening degree of the throttle valve 2, using the above formula (2). The values required for performing the inverse calculation are calculated using the detailed model used for designing the intake system.

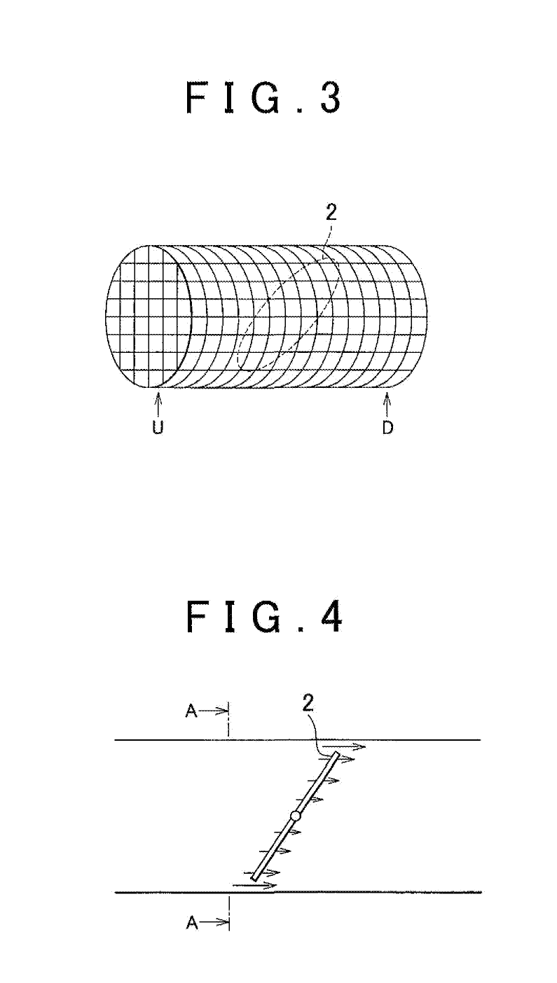

FIG. 3 shows the throttle partial model of the detailed intake system model. As shown in FIG. 3, in the detailed model, each of the partial models is divided into small elements, and pressure, temperature, flow velocity, density, enthalpy, etc., in each element are calculated. If these values are calculated at each value of the opening degree of the throttle valve 2 when the intake system is designed, these values can be used in the inverse calculation performed to determine the flow coefficient Ct (TA) at each value of the opening degree of the throttle valve 2 using the above formula (2).

In other words, the flow coefficient Ct (TA) at each value of the opening degree of the throttle valve 2 can be determined through the inverse calculation using the above formula (2) based on the flow rate m of the intake air that passes through the throttle valve 2, the opening area At around the throttle valve 2, which varies depending on the throttle valve opening degree TA of the throttle valve 2 (the opening area will be hereinafter referred to as “the opening area At (TA)”), the pressure Pin of the intake air that flows into the throttle partial model M2, the pressure Pout of the intake air that flows out of the throttle partial model M2, and the temperature T of the intake air, at each value of the opening degree of the throttle valve 2.

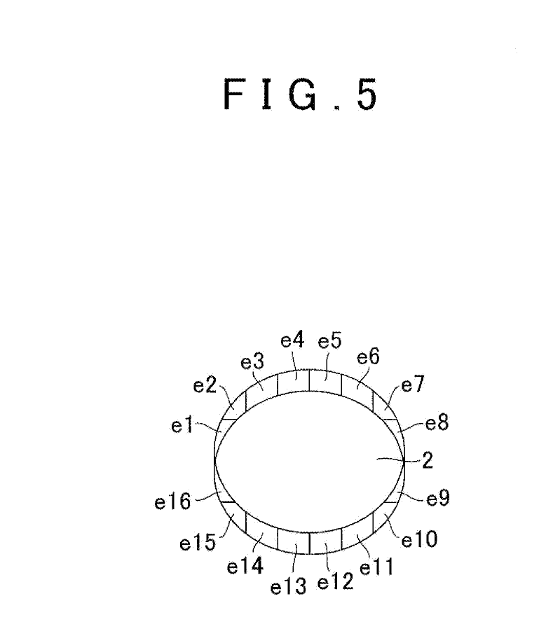

Note that, the temperature T of the intake air may be set to standard atmospheric temperature, and the opening area At around the throttle valve 2 at each value of the opening degree of the throttle valve 2 may be calculated as a design value. For the flow rate m, the pressure Pin, and the pressure Pout of the intake air used in the inverse calculation as described above, the values, which are calculated at each value of the opening degree of the throttle valve 2 using the detailed model when the atmospheric temperature is set to the standard atmospheric temperature and the atmospheric pressure is set to the standard atmospheric pressure, may be used. FIG. 4 is a schematic sectional view of the throttle partial model in a longitudinal direction of the intake passage, and FIG. 5 is a sectional view taken along the line A-A in FIG. 4.

As shown in FIGS. 4 and 5, for example, elements en (n=1 to 16) around the throttle valve 2 are set by dividing the cross section of the intake passage. The value of the intake air flow rate vn×ρn×an in each element en is calculated by multiplying the product of the flow velocity vn and the density ρn of the intake air, which are calculated using the detailed model, by a sectional area an of the element en (the area of the element en as shown in FIG. 5). The calculated values of the flow rate in all the elements en are then added up (v1×ρ1×a1+v2×ρ2×a2+ . . . +v16×ρ16×a16) so as to determine the flow rate m of the intake air that passes through the throttle valve 2. Note that, the term “element” used herein signifies each of the elements e1 to e16 set by dividing the cross section of the intake passage taken along the line A-A in FIG. 4, that is, at the most upstream end of the throttle partial model of the detailed model, as shown in FIG. 5. If the throttle valve opening degree TA varies, the sectional area an of each element also varies, as well as the flow velocity vn and the density ρn calculated using the detailed model.

The pressure Pin of the intake air may be set to an average of the pressure values calculated in the elements located at the most upstream end of the throttle partial model of the detailed model (that is, at U in FIG. 3). Further, the pressure Pout of the intake air may be set to an average of the pressure values calculated in the elements located at the most downstream end of the throttle partial model of the detailed model (that is, at D in FIG. 3).

The air cleaner partial model M1 also includes the flow coefficient C. The flow coefficient C is the conformance value for making the air cleaner partial model M1 conform to the actual engine, and can be therefore determined by performing the inverse calculation using the modeling formula (1) used for modeling the air cleaner 1. Accordingly, the conformance testing is omitted. The inverse calculation for determining the flow coefficient C requires the flow rate m of the intake air that passes through the air cleaner 1; the pressure Pin of the intake air that flows into the air cleaner 1; and the pressure Pout of the intake air that flows out of the air cleaner 1. The flow coefficient C of the air cleaner 1 is a constant value regardless of the opening degree of the throttle valve 2, and is determined by the inverse calculation performed based on the values that are calculated at a certain opening degree of the throttle valve 2 at which the flow rate of the intake air is relatively high (for example, the opening degree at which the throttle valve 2 is half-open, or fully-open), using the detailed model when the atmospheric temperature is set to the standard atmospheric temperature and the atmospheric pressure is set to the standard atmospheric pressure.

The pressure Pin of the intake air that flows into the air cleaner 1 may be set to the standard atmospheric pressure. Because the air cleaner partial model M1 is connected to the throttle partial model M2, the pressure Pout of the intake air that flows out of the air cleaner 1 is set to an average of the pressure values in the elements located at the most upstream end of the throttle partial model of the detailed model (that is, at U in FIG. 3), which are calculated at the certain opening degree of the throttle valve 2. Further, the flow rate m of the intake air that passes through the air cleaner 1 can be determined using the calculation method similar to the calculation method used for calculating the flow rate of the intake air that passes through the throttle valve 2. That is, the flow rate m of the intake air that passes through the air cleaner 1 can be determined by the calculation method in which (a) the value of the intake air flow rate vn×ρn×an in each of the elements located at the most upstream end of the throttle partial model of the detailed model (that is, at U in FIG. 3) is calculated by multiplying the product of the flow velocity vn and the density ρn in the element, which are calculated at the certain opening degree using the detailed model, by the sectional area an of the element; and (b) the values of the intake air flow rate vn×ρn×an in all the elements are added up. In summary, the flow rate m is determined using formula (5) below.

$$m = {\sum }_{i = 1}^{n} vi \times ρ i \times ai \qquad ( 5 )$$

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A model simplification method for model-based development for installing a simplified model of a predetermined system of a vehicle, which is different from a detailed model used for designing the predetermined system of the vehicle, in a vehicle ECU so as to control an engine, the method comprising:
performing an inverse calculation to determine a conformance value for making the simplified model conform to an actual engine, using the simplified model; and
calculating a value required for performing the inverse calculation to determine the conformance value, using the detailed model.

2. The model simplification method according to claim 1, wherein
the simplified model includes a plurality of partial models.

3. The model simplification method according to claim 2, wherein
the partial models included in the simplified model are automatically selected from a partial model library for the simplified model so that the partial models included in the simplified model correspond to respective partial models included in the detailed model.

4. The model simplification method according to claim 3, wherein
an order of connecting the partial models included in the simplified model is automatically set in accordance with an order of connecting the partial models included in the detailed model.

5. The model simplification method according to claim 4, wherein
each of the simplified model and the detailed model is a model of an intake system of an internal combustion engine mounted in the vehicle, and the conformance value for making the simplified model conform to the actual engine is a flow coefficient of intake air that passes through a throttle valve.

6. The model simplification method according to claim 3, wherein
each of the simplified model and the detailed model is a model of an intake system of an internal combustion engine mounted in the vehicle, and the conformance value for making the simplified model conform to the actual engine is a flow coefficient of intake air that passes through a throttle valve.

7. The model simplification method according to claim 2, wherein
each of the simplified model and the detailed model is a model of an intake system of an internal combustion engine mounted in the vehicle, and the conformance value for making the simplified model conform to the actual engine is a flow coefficient of intake air that passes through a throttle valve.

8. The model simplification method according to claim 2, wherein
the partial models include an air cleaner partial model, a throttle partial model, a surge tank partial model, and an intake port partial model.

9. The model simplification method according to claim 8, wherein
a pressure of intake air that flows into the air cleaner partial model is set to standard atmospheric pressure.

10. The model simplification method according to claim 8, wherein
a pressure value of intake air that flows out of the air cleaner partial model is set to an average of pressure values in elements that are set by dividing a cross section of an intake passage at a most upstream end of the throttle partial model.

11. The model simplification method according to claim 8, wherein
a flow rate of intake air that passes through the air cleaner partial model is determined by calculating a value by multiplying a product of a flow velocity vn and a density ρn in each of elements located at a most upstream end of the throttle partial model by a sectional area an of the element, and adding up all the values, as shown by a formula below.
$$m = {\sum }_{i = 1}^{n} vi \times ρ i \times ai$$

12. The model simplification method according to claim 8, wherein
each of the simplified model and the detailed model is a model of an intake system of an internal combustion engine mounted in the vehicle, and the conformance value for making the simplified model conform to the actual engine is a flow coefficient of intake air that passes through a throttle valve.
